(19) United States
(12) Patent Application Publication
(10) Pub. No.: US 2026/0097543 A1
(43) Pub. Date: Apr. 9, 2026

(54) MACHINE FOR ROTATIONAL MOULDING

(71) Applicant: PERSICO S.P.A., NEMBRO (IT)

(72) Inventors: Paolo AMBROSINI, NEMBRO (IT); Andrea FUMAGALLI, NEMBRO (IT); Matteo RADI, NEMBRO (IT)

(21) Appl. No.: 19/115,565

(22) PCT Filed: Sep. 20, 2023
(86) PCT No.: PCT/IT2023/050214

§ 371 Date: Mar. 26, 2025

(30) Foreign Application Priority Data
Sep. 27, 2022 (IT) 102022000019770

(51) Int. Cl. B29C 41/06

(52) U.S. Cl. CPC B29C 41/06

(57) ABSTRACT

Machine (1) for rotational moulding comprising a fixed frame (2); a support arm (3) comprising a first (4) and a second portion (5) and rotationally fixed to the fixed frame (2) to rotate about a first axis of rotation (100) substantially horizontal, wherein main development lines (300, 301) of the first (4) and second portion (5) define a main development plane (500) of the support arm (3) comprising the first axis of rotation (100); a mould interface system (6) removably coupled to the support arm (3) and structured 2024/069660 for securing a mould (20) and for rotating the mould (20) about a second axis of rotation (200) substantially perpendicular to the first axis of rotation (100) and to the main development plane (500), wherein the mould interface system (6) comprises a first (10) and a second support (11) for the mould (20) arranged at a mutual distance parallelly to the second axis of rotation (200), wherein the first support (10) comprises a motor (18) for rotating the mould (20) and the second support (11) comprises a rotating element (19) rotatable.

### TECHNICAL FIELD OF THE INVENTION

The present invention relates to a machine for rotational moulding, in particular suitable for the rotational moulding of hydrogen tanks, and/or components of hydrogen tanks (e.g. internal lining of the tank, also known as “liner”).

### STATE OF THE ART

Rotational moulding is a moulding technology typically used to realize finished products typically made of plastic material comprising an inner cavity that can be opened, i.e. in communication with the environment outside the finished product, or closed, i.e. without the aforementioned communication. Objects typically made using rotational moulding technology are for example: parts of motor vehicles (e.g. roofs for trucks, tractors, etc.), boats (e.g. kayaks), tanks/cisterns (e.g. for fuel, water, hydrogen, etc.) and /r components of such tanks/cisterns (e.g. “liners”), bins, vases, street furniture, toys, garden furniture, etc.

Document CN109571835A discloses an equipment for moulding of the inner liner of a high-pressure hydrogen storing tank.

### SUMMARY OF THE INVENTION

In the context of the processes of rotational moulding, the Applicant considers that known machines for rotational moulding have some drawbacks and/or can be improved under one or more aspects.

This applies for example to the machine for rotational moulding described in CN109571835A, which is equipped with a first horizontal axis of rotation with respect to which an L-shaped arm rotates, the latter being equipped with a rotating plate around a second axis of rotation (in jargon called “roll axis”), perpendicular to the first axis.

According to the Applicant, this machine is not very versatile given the wide variability in the dimensions of the moulds typically used in the sector, due to the type of attachment of the mould. In fact, the mould, once fixed to the machine, develops longitudinally away from the rotating plate.

This positioning of the mould in the machine of CN109571835A makes it necessary, in order to perform the moulding process, to initially rotate the L-shaped arm by approximately 90° to bring the mould (and therefore the second axis of rotation) into a substantially horizontal position, and, only subsequently, rotate the mould with respect to the second axis of rotation, in jargon called “roll”, typically together with an oscillation of the L-shaped arm around the previously reached position, in jargon called “rock”.

In use the mould is therefore positioned completely cantilevered with respect to the rotating plate that supports it.

This negatively affects the maximum dimensions of the moulds that can be used, since it is necessary to limit the overall mass of the mould to avoid considerable efforts at the rotating plate and/or the L-shaped arm, as well as excessive unbalancing of the assembly during the moulding process, with consequent instability of the machine (which can lead to safety problems), and/or possible problems in the realization of the product (defects, thinning of thickness, etc.).

Furthermore, precisely because of the aforementioned method of securing of the mould to the machine, the structure for securing the mould, as well as the mould itself, must respect strict construction and/or geometric constraints, as any variations in mass and/or shape not axially symmetrical with respect to the second axis of rotation would cause eccentricities during the rotation of the mould, with consequent instability of the rotation (e.g. oscillations, vibrations) and related stress on the securing means, as well as further unbalancing problems.

The Applicant has therefore faced the problem of realizing a machine for rotational moulding capable of operationally using, in a stable and robust way, moulds with dimensions variable in a wide range.

According to the Applicant the aforementioned problem is solved by a machine for rotational moulding according to the attached claims and/or having one or more of the following features.

According to an aspect the invention relates to a machine for rotational moulding. The machine comprises:
a fixed frame;
a support arm comprising a first and a second portion rigidly joined together, said support arm being rotationally fixed to said fixed frame (only) at said first portion to rotate about a first axis of rotation (substantially) horizontal, wherein the second portion develops protruding from the first portion (substantially) parallelly to said first axis of rotation, wherein main development lines of said first and second portion define a main development plane of the support arm comprising said first axis of rotation;
a mould interface system (removably) coupled to said support arm at said second portion,
   wherein said mould interface system is structured for (removably) securing a mould and for rotating said mould about a second axis of rotation (substantially) perpendicular to said first axis of rotation and (substantially) perpendicular to said main development plane of the support arm,
   wherein said mould interface system comprises a first and a second support for said mould arranged at a mutual distance parallelly to said second axis of rotation, wherein said first support comprises a motor for rotating the mould about said second axis of rotation, and said second support comprises a rotating element rotatable in idle way for (inferiorly) supporting the mould in rotation.

According to the Applicant, the mould interface system structured for securing the mould as described above ensures that the mould during the process is arranged vertically superiorly to the second portion of the support arm and not arranged cantilevered with respect to the latter, allowing to reduce the mechanical efforts undergone by the machine.

In this way it is therefore possible to accommodate moulds of various dimensions, even large ones. Furthermore, the aforementioned configuration of the machine allows a uniform distribution of the mass and of the encumbrance of the mould during the rotation, contributing to limit any unbalances and the consequent mechanical efforts.

The first and the second support (one motorized and the other idle) allow to support the mould in two positions spatially distributed along the second axis, further facilitating the uniform distribution of the mass of the mould on the support arm, thus limiting any bendings and/or or twisting of the mould and/or of the joints, even as the dimensions of the mould increase.

The terms “horizontal”, “vertical” are used with reference respectively to a direction parallel to, and to a direction perpendicular to, a support plane of the machine in normal operating conditions.

By “substantially horizontal/vertical” in relation to an element of the machine it is meant that this element forms with the horizontal/vertical direction an angle of 0°+/−15°, preferably 0°+/−10°.

By ‘substantially perpendicular’ in relation to geometric elements (such as lines, planes, surfaces, etc.) it is meant that these elements form an angle of 90°+/−15°, preferably 90°+/−10°.

By ‘substantially parallel’ in relation to the aforementioned geometric elements it is meant that these elements form an angle of 0°+/−15°, preferably 0°+/−10°.

The term “longitudinal” refers to a direction substantially parallel to the second axis of rotation.

The present invention in one or more of the aforementioned aspects may exhibit one or more of the following preferred features.

Preferably said support arm has a substantially L-shaped profile, more preferably it is in a single body. In other words, the main development lines of the first and of the second portion are substantially straight and mutually substantially perpendicular, the main development plane being defined by these L-shaped straight lines. In this way the support arm has a simple shape while maintaining the second portion protruding from the first. The present invention comprises any shape of the support arm, for example where the first and second portion are rectilinear, or wherein at least one (e.g. the second portion) has an arcuate or contiguous segments shape, or even wherein the second portion has plate-like shape (e.g. a plate parallel to the first axis of rotation), being understood that the second portion protrudes from the first portion developing substantially parallelly to the first axis of rotation.

Preferably said mould interface system comprises a first frame mechanically fixed to said support arm. In this way the system is coupled to the support arm.

Preferably said first frame has reticular structure (i.e. formed by rods joined together), more preferably with shape of parallelepiped. In this way the frame is rational, robust and at the same time light.

Preferably said reticular structure comprises four vertical uprights and, in distal position from said second portion of the support arm, four upper crosspieces (two substantially parallel to the second axis of rotation and two substantially perpendicular to this) which connect said four vertical uprights to each other. In this way the structure is simple and robust.

Preferably said first support comprises a first fixed element, integral to (e.g. rigidly fixed to, or in single piece with) said first frame, and a first movable element, rotationally connected to said first fixed element for rotating, with respect to said first fixed element, about said second axis of rotation, said first movable element supporting (in use) said mould. Preferably said motor is mechanically connected to the first movable element to rotate the first movable element. In this way the first rotating support is realized in a simple way.

Preferably a main body of said motor is integral to said first frame.

Preferably said first fixed element comprises a through opening of circular shape centred in said second axis of rotation. Preferably said first movable element has annular shape centred in said second axis of rotation. Preferably said first movable element is arranged at said through opening, more preferably at an edge of said through opening. In this way the first support is robust and free space is created to allow the arrangement of the mould.

Preferably said first support comprises a mechanical connection element rigidly fixable to said first movable element, preferably having one or more respective securing portions intended for securing said mould, more preferably angularly distributed (in use) with respect to said second axis of rotation.

Preferably said mechanical connection element has annular shape (e.g. plate-like) centred (in use) in said second axis of rotation. In this way it is realized a first rotating support robust and capable of supporting the mould uniformly for any degree of rotation of the mould. The mechanical connection element, removably fixable to the first movable element, facilitates the operations of securing and un-securing of the mould, as better described below.

Preferably said first fixed element is rigidly fixed to a first vertical face of said reticular structure. In this way the reticular structure supports the weight of the mould, without at the same time spatially interfering with the mould, which for example can extend internally to the empty portions of the reticular structure (e.g. between two uprights and inferiorly to the upper crosspieces).

Preferably said rotating element of said second support is rotationally fixed to said first frame in lower position (e.g. proximal to the second portion support arm), more preferably at a second vertical face of said reticular structure opposite to said first vertical face with reference to said second axis of rotation. In this way it is achieved in a robust way the aforementioned mutual distance of the two rotating supports.

Preferably said rotating element has a respective axis of rotation (substantially) parallel to said second axis of rotation. In this way it is suitably arranged to support the mould in rotation (rotating in turn dragged by the rotation of the mould).

Preferably said second support comprises a second movable element having annular shape (e.g. plate-like) centred (in use) in said second axis of rotation. Preferably said second movable element stands in rotation on said rotating element, said second movable element supporting (in use) said mould.

Preferably said second support comprises a further second movable element, having annular shape centred (in use) in said second axis of rotation. Preferably said further second movable element is rigidly connected to said second movable element at a mutual distance along said second axis of rotation, adjustable as a function of a longitudinal length of the mould. Preferably said further second movable element comprises one or more respective securing portions intended for securing said mould, more preferably (in use) angularly distributed with respect to said second axis of rotation. In this way also the second support for the mould is realized in a constructional simple way. Preferably, said adjustable mutual distance allows the further second movable element to be positioned from time to time at a longitudinal end portion of the mould, keeping the second movable element always at the rotating element.

Preferably said further second movable element supports further operating systems useful for the moulding process, such as for example a system for opening an openable end of the mould and/or a system for positioning an insert to be co-moulded.

Preferably said mould interface system comprises a set of securing brackets for securing, in removably way, said mould to said first support (e.g. to said mechanical connection element) and to said second support (e.g. to the further second movable element) according to securing directions radially arranged with respect to said second axis of rotation (the securing brackets are preferably mechanically connected to the mechanical connection element and to the further second movable element at the respective securing portions). Preferably said securing brackets of said set are angularly distributed about the second axis of rotation. In this way the securing is robust.

Preferably said securing brackets have a translational degree of freedom with respect to the second support (e.g. by means of a coupling with pins which slidingly engage holes) along the second axis of rotation. In this way the longitudinal thermal expansions of the mould are compensated.

Preferably said mould interface system comprises a second frame structured to mechanically connect said mould with said first frame. Preferably said mould is rigidly fixable to said second frame. Preferably said set of securing brackets removably fixes said mould to said second frame.

Preferably said second frame has a rigid structure, more preferably substantially cylindrical.

Preferably said second frame comprises said mechanical connection element, said second movable element and said further second movable element.

Preferably said second frame comprises a set of bars (in use) parallel to (and angularly distributed about) said second axis of rotation and which rigidly connect said mechanical connection element, said second movable element and said further second movable element to each other. Preferably said mechanical connection element is fixed to a first end of said bars and said further second movable element is fixed to a second end of said bars opposite to said first end (with said second movable element interposed between said mechanical connection element and said further second movable element). Preferably said mechanical connection element, in use, is rigidly connected to said first movable element.

In use, typically the mould is first rigidly fixed to the second frame and subsequently the second frame is inserted in the first frame and fixed to the first movable element of the first support by means of the mechanical connection element. The second movable element is typically placed in rotation on the rotating element.

The arrangement of the second frame can facilitate the operations of assembling the mould on the machine, comprising those of adapting the machine to the (variable) dimensions of the mould (as better explained below).

Preferably said rotating element comprises at least a first wheel (or roller), more preferably also a second wheel. In this way the support stability is improved.

Preferably said second support comprises a further rotating element rotatable in idle way, arranged at opposite side of said second movable element with respect to said rotating element. Preferably said further rotating element is rotationally fixed to an upper portion of said first frame (e.g. distal from the second portion of the support arm, for example fixed to one of said upper crosspieces). Preferably said second movable element rotates in rolling contact with said further rotating element. Preferably said further rotating element comprises a respective wheel (or roller). In this way it is enhanced keeping the mould centred in the second axis of rotation during the rotation.

Preferably said second movable element (also) has a translational degree of freedom with respect to said rotating element (and possibly also with respect to said further rotating element) (substantially) along said second axis of rotation. In this way the second movable element is free to slide axially with respect to the wheels whilst maintaining the rolling contact (at least for the entire thickness of the wheels), thus helping to compensate for any thermal expansion of the mould, which could lead to an axial displacement of the second movable support, while maintaining the contact with the wheels.

Preferably an upper crosspiece arranged in vertically superior position with respect to said second movable element (e.g. the upper crosspiece to which the further rotating element is rotationally fixed) is removably (e.g. in a rapid and non-destructive way) fixed to the respective uprights. In this way it is possible disassembling this upper crosspiece to facilitate the removal of the mould from the first frame (together with the second frame rigidly fixed to the mould), improving the speed of operation and reducing downtime.

Preferably said machine comprises an electrical power supply system structured for transferring electrical signals from said fixed frame to said mould when secured to said mould interface system. In this way it is possible to power the mould systems, such as electric resistors to heat the mould, pneumatic systems, etc.

Preferably said machine comprises a forced (and possibly thermo-conditioned) air cooling system comprising a plurality of air outlet mouths (preferably arranged in sequence parallelly to said second axis of rotation), facing (in use) towards said mould.

Preferably said outlet mouths are organized in sets (e.g. rows) arranged at angularly distributed positions about the second axis of rotation. In this way the mould is cooled in conjunction with the rotation of the mould itself.

Preferably said cooling system comprises a fan and a duct which connects the fan to said plurality of outlet mouths. Preferably said fan, said duct and said plurality of mouths are integral with said first frame. In this way the system is stable and robust, as well as positioned close to the mould.

Preferably said machine comprises an adaptation kit (to adapt the machine to the variable dimensions of the moulds).

Preferably said adaptation kit comprises a plurality of spacing elements (preferably all having the same thickness, more preferably identical to each other) positionable in any number between said second portion of the support arm and said first frame. In this way, as the length of the mould increases, it is possible to arrange an appropriate number of spacing elements to increase the distance between the first frame and the second portion of the support arm to still guarantee a sufficient angle of rotation of the mould about the first axis of rotation, avoiding the risk of the ends of the mould to collide with the ground.

Preferably said adaptation kit comprises a plurality of sets of bars, each set being suitable for rigidly connecting said mechanical connection element, said second movable element and said further second movable element to each other. Preferably each set of bars comprises bars all having equal longitudinal length, wherein the bars of different sets differ in respective longitudinal length. In this way it is possible to select from time to time the set of bars most suitable for the length of the mould.

Preferably said adaptation kit comprises a plurality of sets of securing brackets, each set being suitable for securing, removably, said mould to said first and second support.

Preferably each set of securing brackets comprises securing brackets all having equal length, wherein the securing brackets of different sets differ in respective length. In this way it is possible to select from time to time the set of securing brackets most suitable for the diameter of the mould.

In one embodiment said adaptation kit can comprise a plurality of further second movable elements arranged in succession parallelly to the second axis of rotation at mutual distances, rigidly fixed to each other and fixed to the second movable element.

In this way, for moulds having long longitudinal length, in addition to choosing the most suitable set of bars in term of length, it is possible to arrange several further second movable elements. In this way the structure of the second frame is strengthened (e.g. against bending and/or torsion) as the longitudinal length of the mould increases (expanding the length of the second frame to ensure that the mould is substantially entirely enclosed by the second frame).

The adaptation kit makes the machine widely versatile making it is able to use, with limited adaptation operations (i.e. consisting in the most appropriate choice of the set of bars, of the set of securing brackets, of the spacing elements and possibly of the plurality of further second movable elements), moulds with different dimensions in length and/or diameter.

According to an aspect the invention relates to an assembly comprising said machine for rotational moulding according to the present invention and a mould secured to said mould interface system for rotating about said first and second axis of rotation.

Preferably said mould comprises a main development direction. For example, the mould has substantially cylindrical shape with central axis of symmetry.

Preferably, with said mould secured to said mould interface system, said main development direction (more preferably said central symmetry axis) of said mould is parallel to said second axis of rotation, more preferably coinciding with said second axis of rotation. In this way the unbalances during rotation are limited.

Preferably said mould comprises (at least) a pair of securing elements (e.g. a pair of flanges), each securing element being more preferably arranged at a longitudinal end portion of said mould and structured for (removably) securing said mould to said mould interface system (e.g. to said second frame), more preferably to said first and second support, e.g. respectively to said mechanical connection element and to said further second movable element. In this way the mould is suitably shaped to allow the securing thereof.

Preferably each securing element comprises one or more respective securing portions (structured to each receive a respective securing bracket) angularly distributed on the corresponding securing element with respect to said main development direction (more preferably said central axis of symmetry). In this way they are suitably arranged to align with the securing portions of the mould interface system.

Preferably said assembly comprises, at each longitudinal end portion of the mould, a respective opening system for opening the longitudinal end portion of the mould.

Preferably each respective opening system comprises respective guides with longitudinal development, respectively fixed to said first support (e.g. to said mechanical connection element) and to said second support (e.g. to said further second movable element), the guides being slidingly engaged, along the longitudinal direction, by a respective main body of the respective opening system, each main body being rigidly fixed to the respective longitudinal end portion. In this way it is possible to easily insert into the mould any inserts to be co-moulded together with the finished piece, and/or extract the finished price from the mould.

Preferably said assembly comprises, for each opening system, a respective insert-carrying (e.g. pneumatic) cylinder, preferably fixed to said respective main body of the respective opening system.

### BRIEF DESCRIPTION OF THE FIGURES

FIG. 1 shows a perspective view of an assembly comprising a machine for rotational moulding according to the present invention and a mould;

FIG. 2 shows a perspective view of a detail of FIG. 1;

FIGS. 3-5 show a perspective view of a respective portion of an exploded view of FIG. 2.

### DETAILED DESCRIPTION OF SOME EMBODIMENTS OF THE INVENTION

The features and the advantages of the present invention will be further clarified by the following detailed description of some embodiments, presented by way of not limiting example of the present invention, with reference to the attached figures.

In the figures with the number 99 it is indicated an assembly comprising a machine 1 for rotational moulding and a mould 20.

The machine 1 comprises a fixed frame 2 (firmly resting on the ground, possibly constrained to the ground) and a support arm 3 comprising a first portion 4 and a second portion 5 rigidly joined together. Exemplarily the support arm 3 is rotationally fixed to the fixed frame 2 only at the first portion 4 for rotating about a first horizontal axis of rotation 100.

Exemplarily the support arm 3 has a substantially L-shaped profile, with the first portion which develops vertically and the second portion which develops protruding from the first portion substantially parallelly to the first axis of rotation 100.

Exemplarily the first 4 and the second portion 5 each comprise a respective main development line 300, 301 substantially straight and mutually substantially perpendicular. Exemplarily the second portion comprises two end sections inclined with respect to the horizontal direction, approximable, together with the central horizontal section, by means of a respective rectilinear main development line.

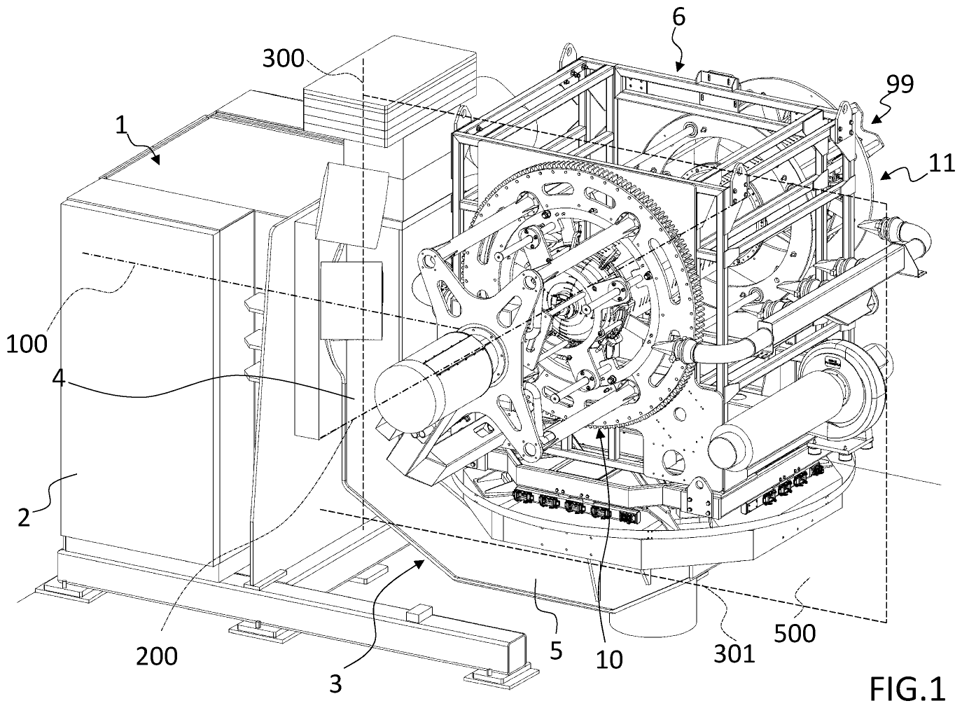

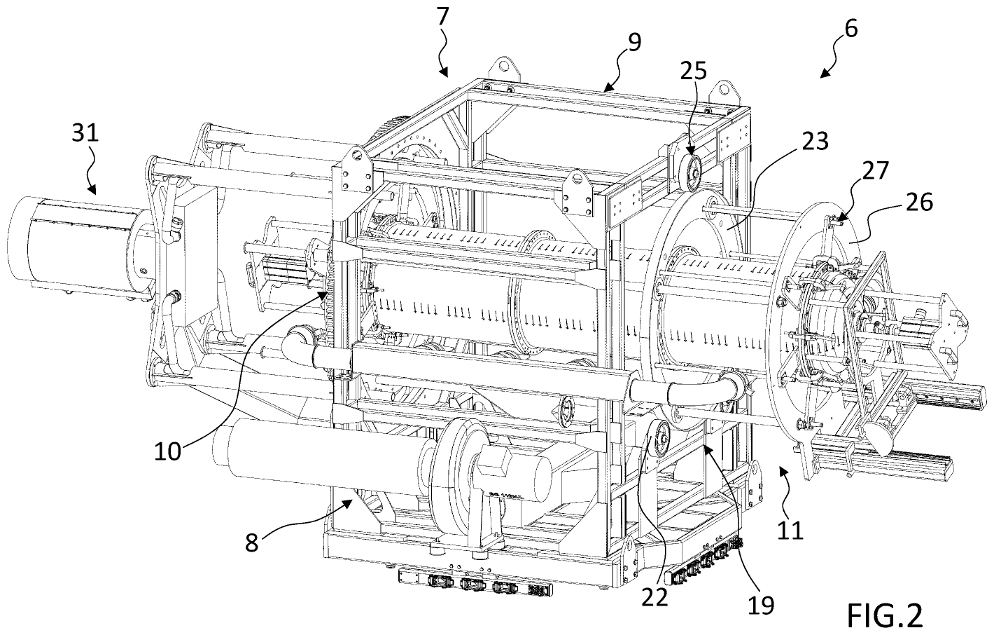

The main development lines 300, 301 of the first 4 and of the second portion 5 define a main development plane 500 of the support arm 3 comprising the first axis of rotation 100 (FIG. 1).

In one alternative embodiment (not shown) the second portion can have plate-like shape arranged horizontally.

The machine 1 also comprises a mould interface system 6, (removably) coupled to the support arm 3 at the second portion 5, and structured for (removably) securing the mould 20 and for rotating the mould 20 about a second axis of rotation 200. Exemplarily the second axis of rotation 200 is perpendicular to the first axis of rotation 100 and perpendicular to the main development plane 500 of the support arm 3.

Exemplarily the mould interface system 6 comprises a first frame 7, mechanically fixed to the support arm 3, and having parallelepiped-shaped reticular structure.

In one embodiment the mould interface system 6 is rigidly fixed to the arm 3.

In one alternative embodiment the mould interface system 6 can be rotationally fixed to the arm 3, being able to rotate about a further axis of rotation (not shown) perpendicular to both the first axis 100 and the second axis 200. In this last embodiment the three axes of rotation machine can also be used in a versatile way for further rotational moulding processes, in addition to the one described here (which does not necessarily require the further axis of rotation). It is understood that in this case there exists at least one configuration of the three axes of rotation machine in which the second axis 200 is perpendicular to the first axis 100, according with the present invention.

Exemplarily the reticular structure comprises four vertical uprights 8 and, in distal position from the second portion 5 of the support arm, four upper crosspieces 9 (two substantially parallel to the second axis of rotation 200 and two perpendicular thereof) which connect to each other the four vertical uprights 8.

Exemplarily the reticular structure also comprises further crosspieces and further uprights, connected to each other as shown in the figures, in order to stiffen the reticular structure.

The mould interface system 6 comprises a first 10 and a second support 11 for the mould 20 arranged at a mutual distance parallelly to the second axis of rotation 200.

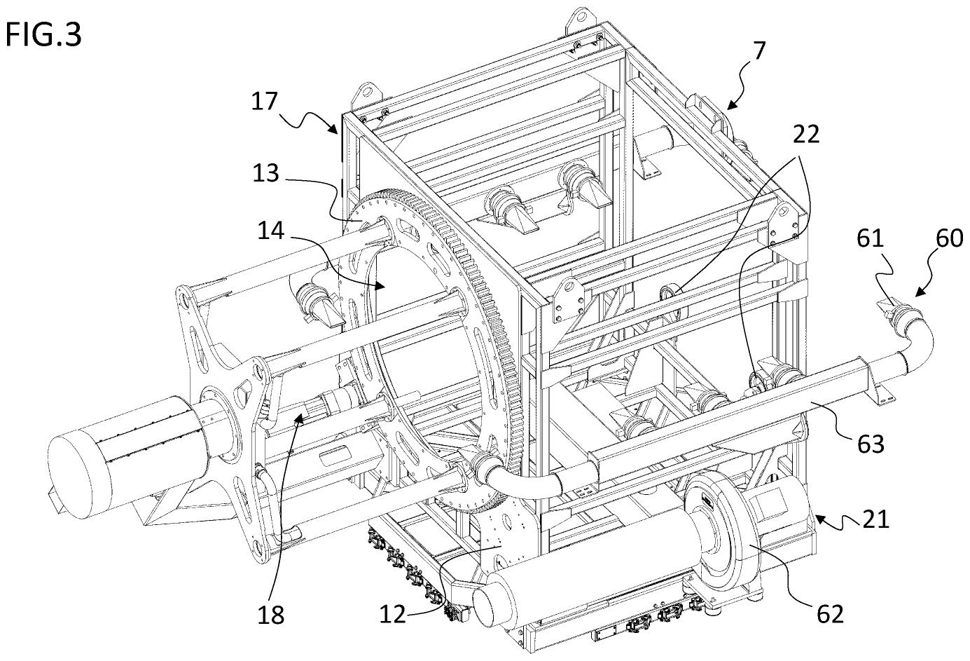

Exemplarily the first support 10 comprises a first fixed element 12, integral with the first frame 7, exemplarily rigidly fixed to a first vertical face 17 of the reticular structure (FIG. 3).

Exemplarily the first support 10 comprises a first movable element 13, rotatably connected to the first fixed element 12 for rotating, with respect to the first fixed element 12, about the second axis of rotation 200.

Exemplarily the first fixed element 12 comprises a circular-shaped through opening 14 centred in the second axis of rotation and the first movable element 13 has annular shape centred in the second axis of rotation, wherein the first movable element is exemplarily arranged at an edge of the through opening, partially occupying the through opening 14 (e.g. fitted on a circular relief which creates a rotation guide thereof, not visible).

The first support 10 comprises a motor 18 for rotating the mould 20 about the second axis of rotation 200. Exemplarily the motor 18 is mechanically connected to the first movable element 13 for rotating the first movable element. Exemplarily the first fixed element and the first movable element of the first support 10 form a fifth-wheel, wherein the first movable element is equipped with a toothed ring nut coupled to a pinion of the motor 18. Exemplarily a main body of the motor 18 is integral with the first frame, in particular it is rigidly fixed directly to the first fixed element.

Exemplarily the first support 10 also comprises a mechanical connection element 15 rigidly fixable to the first movable element 13 and having one or more respective securing portions 16 (exemplarily holes) arranged for securing the mould 20 and angularly distributed (when the mechanical connection element is fixed to the first movable element) with respect to the second axis of rotation 200. Exemplarily the mechanical connection element 15 has annular plate-like shape centred (in use, i.e. when fixed to the first movable element) in the second axis of rotation 200.

The second support 11 comprises a rotating element 19 rotatable in idle way for inferiorly supporting the mould 20 in rotation.

Exemplarily the rotating element 19 is rotationally fixed to the first frame 7 in lower position of the reticular structure and at a second vertical face 21 of the reticular structure opposite to the first vertical face 17 with respect to the second axis of rotation 200.

Exemplarily the rotating element 19 has a respective axis of rotation parallel to the second axis of rotation. Exemplarily the rotating element 19 comprises a first and a second wheel 22.

Exemplarily the second support 11 comprises a second movable element 23 having annular plate-like shape centred, in use (i.e. when the second movable element is placed resting on the rotating element 19, exemplarily on both wheels 22), in the second axis of rotation 200, the second movable element 23 supporting the mould 20.

Exemplarily the second support 11 comprises a further rotating element 25 rotatable in idle way, arranged at opposite side of the second movable element 23 with respect to the rotating element 19. Exemplarily the further rotating element 25 is rotationally fixed to an upper crosspiece 9 of the first frame 7 and comprises a respective wheel.

Exemplarily this upper crosspiece 9 to which the further rotating element is fixed is removably fixed to the respective vertical uprights 8.

Preferably the second movable element 23 has a translational degree of freedom with respect to the rotating element and to the further rotating element along the second axis of rotation 200. Exemplarily this translational degree of freedom is obtained by realizing the second movable element 23 and each wheel with respective constant radius such that the respective lateral (cylindrical) surfaces result parallel to each other, to allow a partial sliding of the second movable element with respect to the wheels parallelly to the second axis of rotation 200, while maintaining at the same time the mutual rotational contact.

Exemplarily the second support 11 comprises a further second movable element 26, having annular shape centred (in use) in the second axis of rotation 200, the further second movable element 26 being rigidly connected to the second movable element 23 at a mutual distance along the second axis of rotation. Exemplarily this mutual distance is adjustable as a function of a longitudinal length of the mould 20, as better described below. Exemplarily the further second movable element 26 comprises one or more respective securing portions 27 intended for securing the mould, (in use) angularly distributed with respect to the second axis of rotation.

Exemplarily the mould interface system 6 comprises a second frame 28 structured to mechanically connect the mould 20 with the first frame 7, the mould 20 being rigidly fixable to the second frame 28.

Exemplarily the second frame 28 has a substantially cylindrical rigid structure and comprises the mechanical connection element 15, the second movable element 23 and the further second movable element 26.

Exemplarily the second frame 28 comprises a set of bars 29 (in use) parallel to, and angularly distributed about, the second axis of rotation 200 and which rigidly connect the mechanical connection element, the second movable element 23 and the further second movable element 26.

Exemplarily the mechanical connection element 15 is fixed to a first end of the bars 29 and, to a second end of the bars opposite to the first end, it is fixed the further second movable element 26, with the second movable element 23 interposed between the mechanical connection element and the further second movable element.

Exemplarily the mould interface system 6 comprising a set of securing brackets 30 (exemplarily twelve brackets) for securing, in removably way, the mould 20 to the second frame 28, in particular to the mechanical connection element 15 of the first support 10 and to the further second movable element 26 of the second support 11, according to securing directions radial with respect to the second axis of rotation 200.

Exemplarily the securing brackets 30 are mechanically connected to the mechanical connection element 15 and to the further second movable element 26 at the respective securing portions 16, 27.

Exemplarily the securing brackets 30 have a translational degree of freedom with respect to the second support 11, in particular with respect to the further second movable element, along the second axis of rotation 200. Exemplarily this translational degree of freedom is obtained by means of a coupling with pins, integral with the further second movable element, which each engage a respective hole made at one end of the respective securing bracket 30, so that the bracket can move with respect to the pin parallelly to the second axis of rotation 200.

Exemplarily the machine 1 comprises an electrical power supply system 31 structured for transferring electrical signals from the fixed frame 2 to the mould 20 when secured to the mould interface system.

Exemplarily the machine 1 also comprises a forced (and possibly thermo-conditioned) air cooling system 60 comprising a plurality of air outlet mouths 61 facing the mould 20 (when secured to the mould interface system). Exemplarily the outlet mouths 61 are organized in two rows, of four mouths each, having development parallel to the second axis of rotation 200 and arranged at opposite sides with respect to the mould.

Exemplarily the cooling system 60 comprises a fan 62 and a duct 63 which connects the fan 62 to the plurality of outlet mouths 61. Exemplarily the fan, the duct and the plurality of mouths are integral to the first frame 7.

Exemplarily (only partially shown) the machine 1 comprises an adaptation kit to adapt the machine to the variable dimensions of the moulds.

Exemplarily (not shown) the adaptation kit comprises a plurality of identical spacing elements that can be positioned in any number between the second portion 5 of the support arm 3 and the first frame 7.

Exemplarily the adaptation kit comprises a plurality of sets of bars 29 (exemplarily only one set of bars is shown), each set being suitable for rigidly connecting the mechanical connection element 15, the second movable element 23 and the further second movable element 26 to each other. Exemplarily each set of bars comprises bars all having equal longitudinal length, wherein the bars of different sets differ in respective longitudinal length.

Exemplarily the adaptation kit also comprises a plurality of sets of securing brackets 30, each set being suitable for securing, in removably way, the mould 20 to the first and second support (exemplarily to the mechanical connection element 15 and to the further second movable element 26). Exemplarily each set of securing brackets comprise securing brackets all having equal length, wherein the securing brackets of different sets differ in respective length.

In one embodiment, not shown, the adaptation kit can further comprise a plurality of further second movable elements arranged in succession parallelly to the second axis of rotation at mutual distances, rigidly fixed to each other and fixed to the second movable element.

Exemplarily the mould 20 has substantially cylindrical shape with a central axis of symmetry, and longitudinal end portions 52 with spherical cap shape.

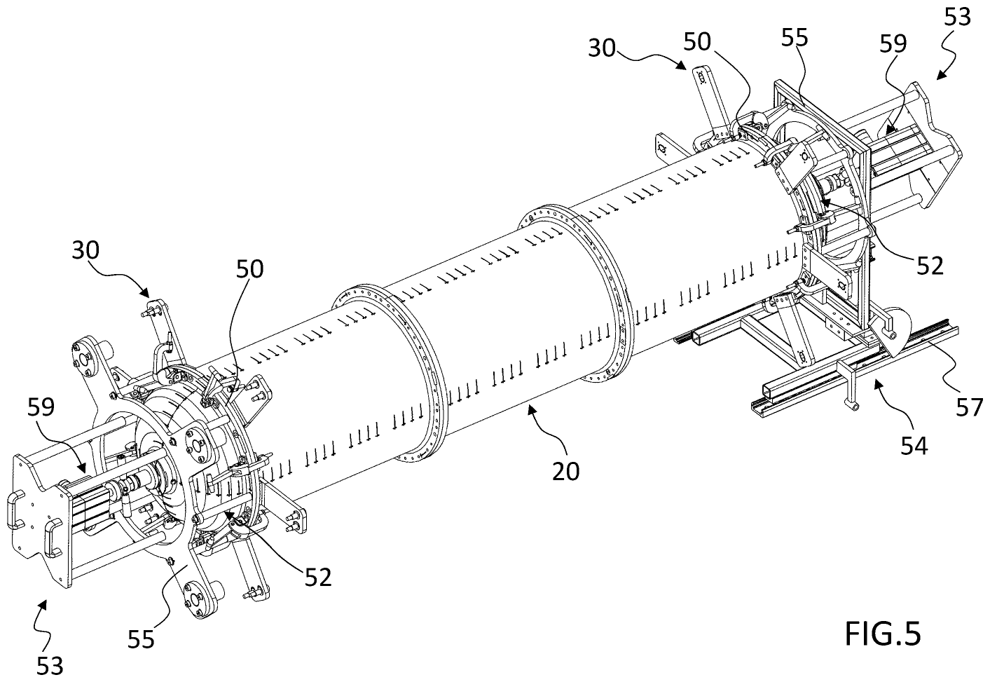

Exemplarily the mould comprises a pair of securing elements 50 each arranged at a respective longitudinal end portion 52 and structured for removably securing the mould to the mould interface system (as better described below). Exemplarily each securing element 50 consists of a respective flange with circumferential development, which is also exemplarily used for securing the respective longitudinal end portion 52 to the rest of the mould. Exemplarily each securing element 50 comprises a plurality of respective securing portions (structured to each receive a respective securing bracket 30, FIG. 5) angularly distributed on the corresponding securing element with respect to the central axis of symmetry of the mould.

Exemplarily both the longitudinal end portions 52 of the mould are openable, for example to remove the finished piece from the mould by extracting it through an open end, and/or to place inside the mould possible inserts which will be co-moulded together with the finished piece during the moulding process. To this end, the assembly 99 exemplarily comprises, at each longitudinal end portion, a respective opening system 53 of the respective longitudinal end portion 52.

Exemplarily each respective opening system 53 comprises respective guides 54 with longitudinal development, fixed respectively to the mechanical connection element 15 and to the further second movable element 26, the guides 54 being slidably engaged, along the longitudinal direction (i.e. substantially parallelly to the second axis of rotation 200), by a respective main body 55 of the respective opening system 53, each main body 55 being rigidly fixed to the respective longitudinal end portion 52.

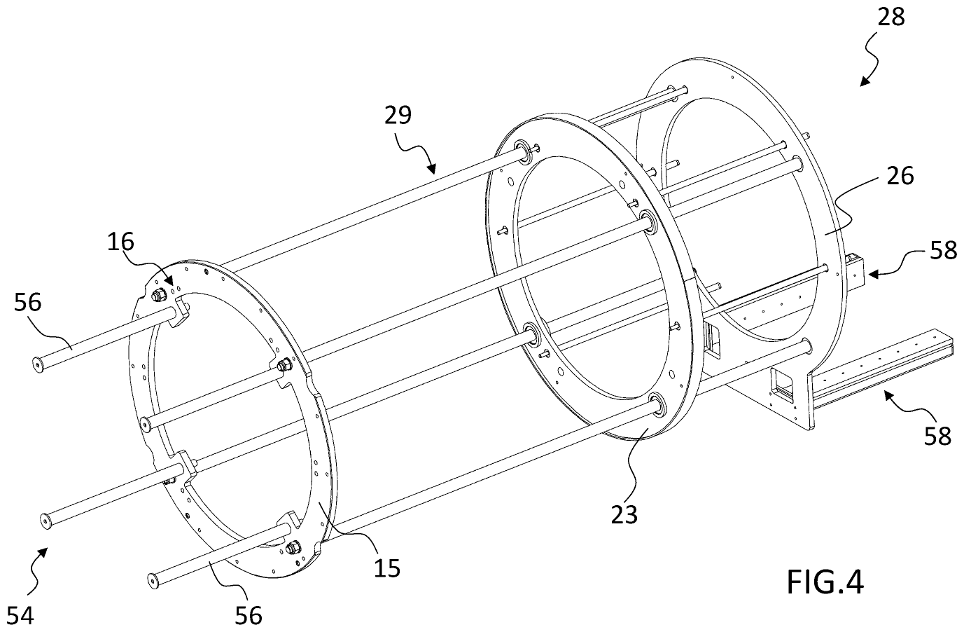

Exemplarily the guides 54 fixed to the mechanical connection element 15 comprise four longitudinal rods 56 (FIG. 4), while the guides 54 fixed to the further second movable element 26 comprise a pair of tracks 57, each track 57 being fixed to a respective housing portion 58 with longitudinal development integral to the further second movable element 26 (FIGS. 4 and 5).

Exemplarily each main body 55 of the opening systems 53 comprises a respective frame equipped with handles to be operated (in one embodiment, not shown, the opening systems can be automatically operated).

Exemplarily the assembly 99 comprises, for each opening system 53, a respective insert-carrying cylinder 59, exemplarily fixed to the respective main body 55 of the respective opening system 53.

Exemplarily, for securing the mould 20 to the machine 1, it is firstly provided selecting from the adaptation kit the appropriate set of bars 29, as a function of the longitudinal length of the mould, and the appropriate set of securing brackets 30, as a function of the diameter of the mould. If necessary, it may also be provided selecting from the adaptation kit an appropriate number of spacing elements to be placed inferiorly to the first frame 7 to distance it from the second portion of the support arm, so as to allow a (partial) rotation of the mould about the first axis of rotation eliminating the risk of the longitudinal end portions 52 of the mould to collide with the ground.

Exemplarily it is therefore provided assembling the second frame 28 by mutually fixing, through the set of bars 29, the mechanical connection element 15, the second movable element 23 and the further second movable element 26. The mutual distance between the second movable element and the further second movable element is therefore adjusted as a function of the longitudinal length of the mould depending on the chosen length of the bars 29.

The mould is therefore connected to the second frame 28 by means of the securing brackets 30 and the opening systems 53 are mechanically connected to the respective longitudinal end portion 52.

Subsequently, the removable upper crosspiece 9 is separated from the rest of the reticular structure to free the passage for the second frame. Exemplarily it is therefore provided inserting the second frame 28 (e.g. by means of a roto-translation movement), together with the mould 20 and the opening systems 53, inside the reticular structure of the first frame 7. Exemplarily the mechanical connection element is placed contact with, and rigidly connected to, the first movable element 13 of the first support 10 at a face of the first movable element facing the reticular structure, the longitudinal end portion 52 proximal to the mechanical connection element 15 being inserted into the circular opening of the first movable element 13, together with the corresponding opening system 53. Exemplarily the second movable element is arranged to rest on both the wheels 22 of the rotating element 19.

Exemplarily with the mould 20 secured to the mould interface system, the central axis of symmetry of the mould coincides with the second axis of rotation 200.

The upper crosspiece 9 previously removed is then fixed again to the rest of the reticular structure, bringing the second movable element 23 into rolling contact with the further rotating element 25.

Finally, the electrical and/or pneumatic connections between the fixed frame of the machine and the mould are exemplarily completed.

In use, the assembly 99 allows to realize a rotational moulding process, in detail the assembly 99 is particularly suitable for a rotational moulding process defined in jargon as “rock and roll” where the mould 20 is made to oscillate (without performing a complete rotation) about the first axis of rotation 100 (“rock” movement) while simultaneously being continuously rotated about the second axis of rotation 200 (“roll” movement).

1. A machine for rotational moulding, the machine comprising:
a fixed frame;
a support arm comprising a first and a second portion rigidly joined together, said support arm being rotationally fixed to said fixed frame at said first portion to rotate about a first axis of rotation substantially horizontal, wherein the second portion develops protruding from the first portion substantially parallelly to said first axis of rotation, wherein main development lines of said first and second portion define a main development plane of the support arm comprising said first axis of rotation;
a mould interface system removably coupled to said support arm at said second portion,
wherein said mould interface system is structured for securing a mould and for rotating said mould about a second axis of rotation substantially perpendicular to said first axis of rotation and substantially perpendicular to said main development plane of the support arm,
wherein said mould interface system comprises a first and a second support for said mould arranged at a mutual distance parallelly to said second axis of rotation wherein said first support comprises a motor for rotating the mould about said second axis of rotation and said second support comprises a rotating element rotatable in idle way for supporting the mould in rotation.

2. The machine according to claim 1, wherein said mould interface system comprises a first frame mechanically fixed to said support arm wherein said first frame has reticular structure comprising four vertical uprights and, in distal position from said second portion of the support arm, four upper crosspieces which connect said four vertical uprights to each other, wherein said first support comprises a first fixed element, integral to said first frame, and a first movable element rotationally connected to said first fixed element for rotating, with respect to said first fixed element, about said second axis of rotation, said first movable element supporting said mould, wherein said motor is mechanically connected to the first movable element to rotate the first movable element, wherein said rotating element of said second support is rotationally fixed to said first frame in lower position, wherein said second support comprises a second movable element having annular shape centred in said second axis of rotation, wherein said second movable element stands in rotation on said rotating element, said second movable element supporting said mould, and wherein said mould interface system comprises a set of securing brackets for securing, in removably way, said mould to said first support and to said second support according to securing directions radially arranged with respect to said second axis of rotation.

3. The machine according to claim 2, wherein said first fixed element comprises a through opening of circular shape centred in said second axis of rotation, wherein said first movable element has annular shape centred in said second axis of rotation, wherein said first movable element is arranged at said through opening, wherein said first support comprises a mechanical connection element rigidly fixable to said first movable element and having one or more respective securing portions intended for securing said mould, wherein said mechanical connection element has annular shape centred in said second axis of rotation and wherein said first fixed element is rigidly fixed to a first vertical face of said reticular structure.

4. The machine according to claim 2, wherein said second support comprises a further second movable element (26), having annular shape centred in said second axis of rotation, wherein said further second movable element is rigidly connected to said second movable element at a mutual distance along said second axis of rotation, adjustable as a function of a longitudinal length of the mould, wherein said further second movable element comprises one or more respective securing portions intended for securing said mould, wherein said rotating element has a respective axis of rotation substantially parallel to said second axis of rotation, wherein said second movable element has a translational degree of freedom with respect to said rotating element substantially along said second axis of rotation, wherein said rotating element is rotationally fixed to said first frame at a second vertical face of said reticular structure opposite to said first vertical face with respect to said second axis of rotation.

5. The machine according to claim 4, wherein said mould interface system comprises a second frame structured to mechanically connect said mould with said first frame wherein said mould is rigidly fixable to said second frame, wherein said second frame has a rigid structure and comprises said mechanical connection element, said second movable element and said further second movable element, wherein said set of securing brackets removably fixes said mould to said second frame, wherein said second frame comprises a set of bars parallel to said second axis of rotation and which rigidly connect said mechanical connection element said second movable element and said further second movable element to each other, wherein said mechanical connection element is fixed to a first end of said bars and said further second movable element is fixed to a second end of said bars opposite to said first end, with said second movable element interposed between said mechanical connection element and said further second movable element, and wherein said mechanical connection element, in use, is rigidly connected to said first movable element.

6. The machine according to claim 2, wherein said rotating element comprises at least a first wheel, wherein said second support comprises a further rotating element rotatable in idle way, arranged at opposite side of said second movable element with respect to said rotating element, wherein said further rotating element is rotationally fixed to an upper portion of said first frame and comprises a respective wheel, wherein said second movable element rotates in rolling contact with said further rotating element, wherein an upper crosspiece arranged in vertically superior position with respect to said second movable element is removably fixed to the respective vertical uprights, wherein said machine comprises a forced air cooling system comprising a plurality of air outlet mouths faced towards the mould, wherein said outlet mouths are organized in sets arranged at angularly distributed positions about the second axis of rotation, wherein said cooling system comprises a fan and a duct which connects the fan to said plurality of outlet mouths, and wherein said fan, said duct and said plurality of mouths are integral to said first frame.

7. The machine according to claim 2, wherein said securing brackets of said set are angularly distributed about the second axis of rotation wherein said securing brackets have a translational degree of freedom with respect to the second support along the second axis of rotation.

8. The machine according to claim 2, comprising an adaptation kit comprising a plurality of spacing elements positionable in any number between said second portion of the support arm and said first frame, a plurality of sets of bars, each set being suitable for rigidly connecting said mechanical connection element, said second movable element and said further second movable element to each other, wherein each set of bars comprises bars all having equal longitudinal length, wherein the bars of different sets differ in respective longitudinal length, and a plurality of sets of securing brackets, each set being suitable for securing, removably, said mould to said first and second support, wherein each set of securing brackets comprises securing brackets all having equal length, wherein the securing brackets of different sets differ in respective length.

9. An assembly comprising said machine for rotational moulding according to claim 1 and a mould secured to said mould interface system for rotating about said first and second axis of rotation, wherein said mould comprises a main development direction, wherein, with said mould secured to said mould interface system, said main development direction of said mould is parallel to said second axis of rotation, and wherein said mould comprises a pair of securing elements, each securing element being arranged at a longitudinal end portion of said mould and structured for securing said mould to said mould interface system

10. The assembly according to claim 9, comprising, at each longitudinal end portion of the mould, a respective opening system for opening the longitudinal end portion of the mould, wherein each respective opening system comprises respective guides with longitudinal development, respectively fixed to said first support and to said second support, the guides being slidingly engaged, along the longitudinal direction, by a respective main body of the respective opening system, each main body being rigidly fixed to the respective longitudinal end portion, and wherein said assembly comprises, for each opening system, a respective insert-carrying cylinder fixed to said respective main body of the respective opening system.
